(19) United States
(12) Patent Application Publication
(10) Pub. No.: US 2011/0300506 A1
(43) Pub. Date: Dec. 8, 2011

(54) Endodontic File With Working Length Adjustment Scale

(75) Inventors: Alexander D. Curry, Burlington, KY (US); Daniel E. Dykes, Alexandria, KY (US); Alex X. Frommeyer, Cold Spring, KY (US); Joseph A. Schab, Burlington, KY (US)

(73) Assignee: INVEN LLC, Louisville, KY (US)

(21) Appl. No.: 12/939,651

(22) Filed: Nov. 4, 2010

Related U.S. Application Data
(60) Provisional application No. 61/352,754, filed on Jun. 8, 2010.

(51) Int. Cl. A61C 19/04; A61C 5/02

(52) U.S. Cl. 433/75; 433/102

(57) ABSTRACT

An endodontic file is provided for use during root canal therapy. The endodontic file has a handle, a blade, and a marker. The marker provides a working length adjustment scale that is integrated with the handle and the blade. After adjustment of the endodontic file to a desired working length, compared to the depth of a subject root canal, the marker is maintained in a substantially static position relative to the blade, which is itself stationary relative to the handle. The endodontic file reduces the chances of unintended complications during root canal therapy, for example if the blade were to penetrate into various tissues located in proximity to the root canal.

### CROSS REFERENCE TO RELATED U.S. APPLICATION

This application claims priority to U.S. Provisional Application No. 61/352,754 filed on Jun. 8, 2010.

### BACKGROUND

Endodontic therapy, otherwise known as root canal treatment, is the treatment of conditions pertaining to the pulp cavity of a tooth. Various kinds of tissues are located in proximity to and within a tooth. These include blood vessels and other matter that are referred to as pulp, and are found within the pulp cavity, which is also known as the root canal of a tooth. When an infection or other undesired condition occurs in a tooth, or in proximity to a tooth, which affects or potentially will affect the root canal, one course of endodontic therapy used by dental professionals involves removing substantially all the matter inside the root canal. Endodontic therapy is practiced by several different kinds of professionals, such as, for example, dentists and endodontists. Herein, the phrase dental professional is meant to include all such professionals who practice endodontic therapy.

In some cases, endodontic therapy includes drilling a hole into the subject tooth, in order to facilitate the removal of substantially all the pulp and other matter contained within the root canal. In many cases, in order to remove the material from the root canal, a dental professional employs an instrument known as an endodontic file. Endodontic files generally have a blade with at least one sharp surface that the dental professional uses to clear the root canal of matter. After the root canal is sufficiently cleared, the dental professional fills the canal with a sealant.

However, other anatomic structures and tissues besides pulp are in proximity to a root canal. During endodontic therapy, the sharp surface of an endodontic file sometimes causes unintended damage to these other anatomic structures and tissues. For example, a surface of the blade may perforate the soft tissues in proximity to the root canal, causing nerve damage or other tissue injury. As further illustration of possible complications from endodontic therapy, the inferior alveolar nerve is located in proximity to the root canals. In some cases, the mechanism of damage involves a sharp surface of an endodontic file perforating the soft tissues in proximity to a root canal, to the point where the surface of the endodontic file penetrates the inferior alveolar canal. In some cases, the contact between the surface of the endodontic file and the nerve or some related tissue is the damaging insult.

Nerve and tissue damage also occurs when a sharp surface of the endodontic file causes a perforation within surrounding tissues, which allows sealant to migrate into an unintended area in proximity to nerve fibers. As the sealant hardens, in some cases the migration causes a compression injury to nerve cells and other tissues. In other cases, the sealant or other chemicals used in the endodontic therapy produce a neurotoxic effect. Such unintended occurrences frequently produce pain or other undesired consequences, such as, for example, loss of nerve function, and may require surgery.

Consequently, dental professionals have sought ways to reduce the chances of unintentionally perforating or penetrating the tissues that are in proximity to a root canal. One such way has been to position a gasket-like ring around the blade, which provides some indication of the depth of the root canal. However, a gasket-like ring is not constrained except by the small frictional forces between the inner surface of the ring and the outer surface of the blade. Consequently, in practice, gasket-like rings move with great ease along the axis of the blade. Moreover, the force that dental professionals use in clearing a root canal of matter easily overcomes the frictional force between the inner surface of the ring and the outer surface of the blade. Consequently, a gasket-like ring will not provide a consistent and reliable indication of the depth of an endodontic file blade in a root canal. The lack of a consistent and reliable indication of the depth of an endodontic file blade in a root canal is a risk factor for purposes of the complications that arise in endodontic therapy.

Moreover, other solutions that have been attempted, such as, for example, those involving a depth measurement that involves the use of a ruler, require separate devices in order to make adjustments to the working length of the endodontic file. These result in a significant expenditure of time, and often result in similar problems regarding a consistent and reliable indication of working length.

### BRIEF DESCRIPTION OF THE DRAWINGS

FIG. 1 is an exploded view of an endodontic file with working length adjustment scale according to multiple embodiments and alternatives.

FIG. 2 is a perspective view of an endodontic file with working length adjustment scale, in relation to a root canal of a tooth, according to multiple embodiments and alternatives.

FIG. 3 is perspective view of an endodontic file with working length adjustment scale according to multiple embodiments and alternatives.

FIG. 4A is a plan view of an endodontic file with working length adjustment scale according to multiple embodiments and alternatives.

FIG. 4B is a cross-sectional view of an endodontic file with working length adjustment scale, taken along line A-A in FIG. 4A, according to multiple embodiments and alternatives.

FIG. 5A is a plan view of an endodontic file with working length adjustment scale according to multiple embodiments and alternatives.

FIG. 5B is a cross-sectional view of an endodontic file with working length adjustment scale, showing further detail in the area of circle B in FIG. 5A, according to multiple embodiments and alternatives.

FIG. 6A is a plan view of an endodontic file with working length adjustment scale according to multiple embodiments and alternatives.

FIG. 6B is a cross-sectional view of an endodontic file with working length adjustment scale, taken along line B-B in FIG. 6A, according to multiple embodiments and alternatives.

FIG. 6C is a cross-sectional view of an endodontic file with working length adjustment scale, showing further detail in the area of circle C in FIG. 6B, according to multiple embodiments and alternatives.

FIG. 7A is a cutaway view of an endodontic file with working length adjustment scale according to multiple embodiments and alternatives.

FIG. 7B is a cross-sectional view of an endodontic file with working length adjustment scale, showing further detail in the area of circle B in FIG. 7A, according to multiple embodiments and alternatives.

FIG. 7C is a cross-sectional view of an endodontic file with working length adjustment scale, showing further detail in the area of circle C in FIG. 7B, according to multiple embodiments and alternatives.

FIG. 8A is a plan view of an endodontic file with working length adjustment scale according to multiple embodiments and alternatives.

FIG. 8B is a cross-sectional view of an endodontic file with working length adjustment scale, taken along line B-B in FIG. 8A, according to multiple embodiments and alternatives.

FIG. 8C is a cross-sectional view of an endodontic file with working length adjustment scale, showing further detail in the area of circle C in FIG. 8B, according to multiple embodiments and alternatives.

FIG. 9A is a plan view of an endodontic file with working length adjustment scale according to multiple embodiments and alternatives.

FIG. 9B is a cross-sectional view of an endodontic file with working length adjustment scale, taken along line A-A in FIG. 9A, according to multiple embodiments and alternatives.

FIG. 10A is a plan view of an endodontic file with working length adjustment scale according to multiple embodiments and alternatives.

FIG. 10B is a cross-sectional view of an endodontic file with working length adjustment scale, taken along line B-B in FIG. 10A, according to multiple embodiments and alternatives.

FIG. 10C is a perspective view of an endodontic file with working length adjustment scale, in relation to a root canal of a tooth, according to multiple embodiments and alternatives.

FIG. 11A is a perspective view of an endodontic file with working length adjustment scale, in relation to an engine device, according to multiple embodiments and alternatives.

FIG. 11B is a cross-sectional view of an endodontic file with working length adjustment scale, showing further detail in the area of circle A in FIG. 11A, according to multiple embodiments and alternatives.

FIG. 12A is a perspective view of an endodontic file with working length adjustment scale, in relation to an engine device and the root canal of a tooth, according to multiple embodiments and alternatives.

FIG. 12B is a perspective view of an endodontic file with working length adjustment scale, in relation to an engine device and the root canal of a tooth, showing further detail in the area of circle A in FIG. 12A, according to multiple embodiments and alternatives.

FIG. 13A is a cutaway view of an endodontic file with working length adjustment scale according to multiple embodiments and alternatives.

FIG. 13B is a plan view of an endodontic file with working length adjustment scale, showing further detail in the area of circle B in FIG. 13A, according to multiple embodiments and alternatives.

FIG. 13C is a cross-sectional view of an endodontic file with working length adjustment scale, showing further detail in the area of circle C in FIG. 13A, according to multiple embodiments and alternatives.

FIG. 14A is a perspective view of an endodontic file with working length adjustment scale according to multiple embodiments and alternatives.

FIG. 14B is a front elevation view of an endodontic file with working length adjustment scale according to multiple embodiments and alternatives.

### MULTIPLE EMBODIMENTS AND ALTERNATIVES

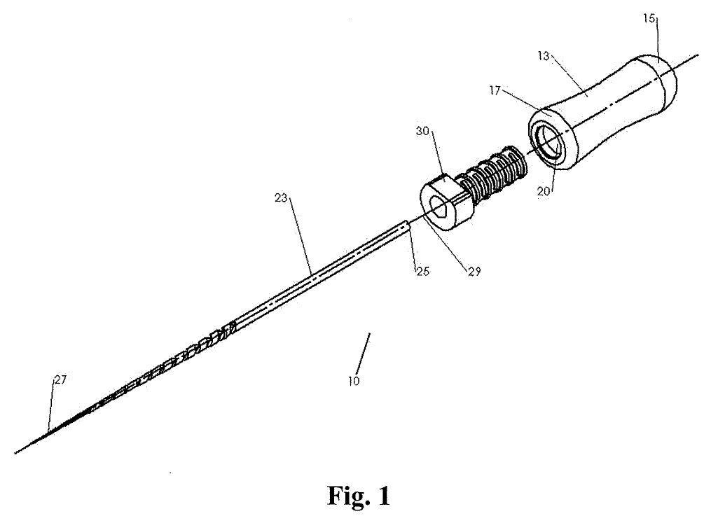

Referring to FIG. 1, an endodontic file with working length adjustment scale 10 (hereafter referred to as endodontic file 10) has a handle 13, a blade 23, and a marker 30. The blade 23 has a proximal end 25 and a distal end 27. The position of the marker 30 enables a dental professional to gauge the working length of the blade 23 relative to a root canal of the tooth. The handle 13 has a proximal end 15 and a distal end 17, and an opening at the distal end 17 leading to an inner cavity 20. In some embodiments, the inner cavity is cylindrically hollow. The blade 23 defines an axial line 29 relative to the handle 13. In some embodiments, the blade 23 is concentric with the cylindrically hollow inner cavity 20 of the handle.

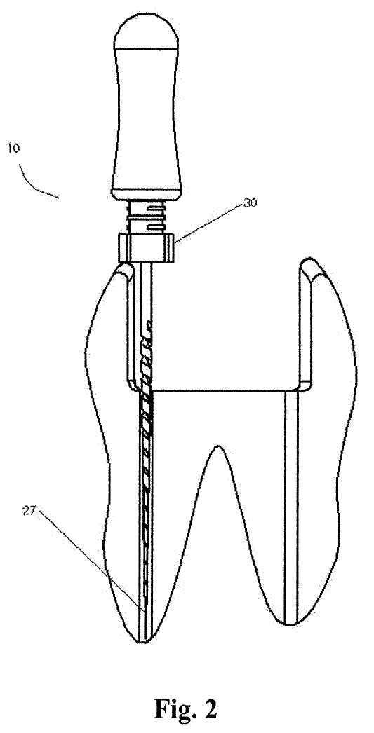

Referring to FIG. 2, the working length of an endodontic file represents that segment of the blade of an endodontic file that is no greater in length than the depth of a particular root canal. Accordingly, working length has the potential to vary from patient to patient and, indeed, even from one tooth to the next for a particular patient. The depth of a root canal is typically expressed in millimeters (mm), as is the working length of an endodontic file. The deepest part of a root canal is typically referred to as the apex. An apical perforation occurs when a surface of the endodontic file penetrates the apex, into other tissues in proximity to the root canal, such as, for example, the inferior alveolar canal. Consequently, if the working length of an endodontic file is less than the depth of a root canal, then the chances of apical perforation are minimized Likewise, the more consistent and reliable the measurement of working length, the less the chances of an apical perforation.

Accordingly, FIG. 2 shows a surface of the marker 30 in substantial contact with the outer portion of a tooth. It also shows the distal end 27 of the blade 23 in proximity to the apex of the root canal, yet not having penetrated the apex. The marker 30 has been adjusted to a position selectably desired by the user, who then places the blade 23 with its distal end 27 first into the root canal, working to remove matter from the canal with the marker 30 serving as a reference point relative to the crown of the tooth. In some embodiments, the contact between the outer portion of the tooth and the marker 30 serves as a physical impediment that keeps the blade 23 from penetrating deeper into the root canal.

Appropriately adjusting the working length of the endodontic file 10 means that the distal-most surface edge of the marker 30 is positioned for making contact with the crown of the tooth, before the tip at the distal end 27 of the blade 23 will penetrate beyond the apex of the root canal. The user repositions the marker 30 in order to adjust the working length of the endodontic file 10 by moving the marker along the axial line 29 either toward the proximal end 25 of the blade 23 or toward the distal end 27. Accordingly, the marker 30 integrated with the blade 23 and handle 13 provides for adjustments to the working length of the endodontic file 10 without the use of a separate device.

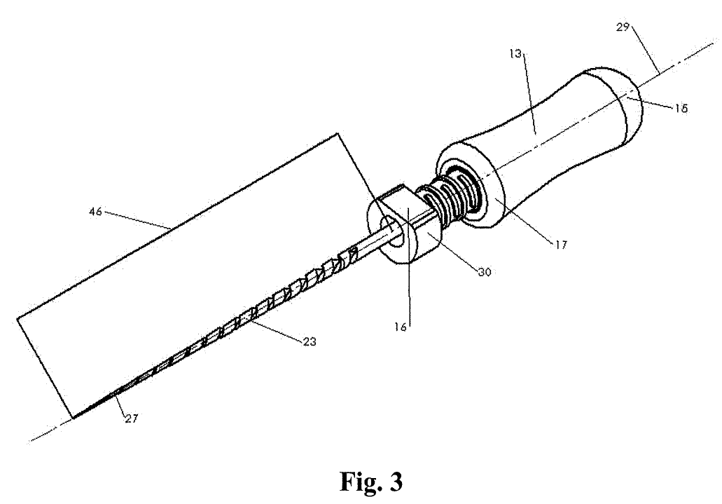

Referring now to FIG. 3, a segment length 46 of blade 23 is the distance from the distal-most surface edge of the marker 30 to the distal end 27 of the blade 23. Because the marker 30 is movable, the segment length 46 represented in FIG. 3 is variable, depending on the adjustments made to the marker 30. In this way, the movable location of the marker 30 provides for a working length adjustment range. Pushing the marker 30 proximally along the blade 23 in the direction of the handle 13 will increase the segment length 46. In turn, this movement will increase the working length of the endodontic file 10. Conversely, pulling the marker 30 distally away from the handle 13, will reduce the segment length 46, and serve to reduce the working length of the endodontic file 10.

In some embodiments, the proximal end 25 of the blade 23 is housed within the handle 13. The handle 13 is contoured such that the outer circumference latitudinally at a central point of the handle is smaller than the diameter of the proximal end 15 and the distal end 17, respectively. Accordingly, the outer surface shape of the handle 13 facilitates manual interaction with the handle 13 of the endodontic file 10 during use by a dental professional. In some embodiments, the contour is formed as a streamlined curve, a parabolic curve, or a hyperbolic curve. Optionally, the outer surface of the proximal end 15 of the handle 13 is rounded.

In some embodiments, the distal end 27 of blade 23 comprises a sharp point. The blade 23 is made for the purpose of cutting into tissues and clearing matter from a root canal. In some embodiments the blade 23 has a tip size according to standard sizes routinely used by dental professionals, as well as a taper toward the distal direction. The taper of the blade 23 encompasses the distal end 27, and it generally terminates at the tip of the blade 23 at the far distal end 27.

The concept of working length is further understood in connection with FIG. 3. In operation, a portion of the blade 23, inclusive of the proximal end 25, is housed within the handle 13. Suppose that the remaining length of the blade 23 (i.e., the portion not housed within the handle 13, inclusive of the distal end 27) is 25 mm, a standard measurement used with endodontic files. This would mean that some of the remaining length of the blade 23 is covered by the marker 30, and some is exposed beyond the marker 30. In this hypothetical example, the length of this exposed portion would be the working length of the endodontic file 10, and is determined by the positioning of the marker 30 parallel to the axial line 29. The working length of the blade 23 is considered to be the length of the blade 23 not counting that portion of the blade 23 that is housed within the handle 13, and not counting that portion that is covered by the marker 30. In some embodiments, this working length is about 17 mm-26 mm, including all values and increments therebetween.

The marker 30 is slidably movable along the blade 23 parallel to the axial line 29. A working length adjustment occurs when a user pushes the marker 30 proximally along the blade 23 in the direction of the handle 13, which increases working length. A working length adjustment also occurs when a user pulls the marker 30 distally away from the handle 13 and toward the distal end 27 of the blade 23, which reduces the working length. This range of motion of the marker provides for a working length adjustment scale. In some embodiments, the working length adjustment scale is about 0.5 mm-12.0 mm, including all values and increments therebetween. This range of motion facilitates the adjustment of the working length for use in connection with a variety of root canal depths, thus reducing the need to maintain a large inventory of different endodontic file classifications and lengths. In some embodiments, the working length adjustment scale is about 3 mm-8 mm, including all values and increments therebetween.

In some instances, a dental professional uses the endodontic file 10 in order to gauge the depth of a root canal of interest prior to cutting and clearing matter from a root canal. The user gauges the depth of the root canal, and then adjusts the positioning of the marker 30 so that the working length of the endodontic file 10 is substantially equal to or, slightly less than, the depth of the subject root canal. After the marker 30 is positioned accordingly, the blade 23 is inserted distal end 27 first into the root canal. When the distal-most surface edge of the marker 30 contacts the crown of the tooth, it provides an indication that (1) the entire working length of the endodontic file 10 has been inserted into the root canal; and (2) the tip at the distal end 27 of the blade 23 is no deeper than the apex of the root canal. In this way, it is possible for the dental professional to relatively quickly and easily place the endodontic file 10 into the root canal consistent with a more safe and accurate working length of the endodontic file 10, while the endodontic file 10 is in contact with the crown of the tooth. While in this position, it is possible for the dental professional to then obtain an x-ray image to confirm the placement of the blade 23 such that the tip at the distal end 27 is no deeper than the apex of the root canal while the distal-most surface edge of the marker 30 is in contact with the crown of the tooth.

Referring still to FIG. 3, in some embodiments, the taper of the blade 23 has an overlaid, tapered helix useful in removing pulp and other matter from the root canal, as well as shaping of the root canal. The taper begins at a point along the working length of the blade 23, with the remainder of the blade 23, including the proximal end 25, comprising a cylindrical shape of uniform diameter and circumference. In some embodiments, the proximal end 25 of the blade 23 includes an overmolded end cap that fits securely into the proximal end 15 of the handle 13. Alternatively, the proximal end 25 of the blade 23 is attached within the handle 13. In some embodiments, the proximal end 25 of the blade 23 is non-cylindrical, such that the inner cavity 20 is of a complementary, non-cylindrical shape that matches the proximal end 25 of the blade.

In some embodiments, the tapered portion at the distal end 27 of the blade 23 is adapted for cutting and clearing of a root canal. Optionally, the tapered portion of the blade 23 comprises a geometric shape, corresponding to a form chosen from the group K-File, Hedstrom File, Helical file, and Reamer. All of these forms are known to those practicing in the pertinent field.

In some embodiments, the marker 30 has a section with a surface 16 for affixing a designation regarding the length of the blade 23, such as, for example, a numerical designation. Alternatively, the numerical designation indicates the tip size of the blade 23, or the taper of the blade 23. Optionally, surface 16 is a relatively flat, enlarged section to accommodate a numerical designation of sufficient size to be easily discernible to the eye, and the designation is glued to the surface 16 or affixed to the surface 16 through other means known to those practicing in the pertinent field. As shown in several drawing figures, including but not limited to FIG. 3, in some embodiments the endodontic file 10 is an unitary instrument, such that the handle 13, blade 23, and marker 30 are integrated into a single instrument and operationally remain in contact with each other.

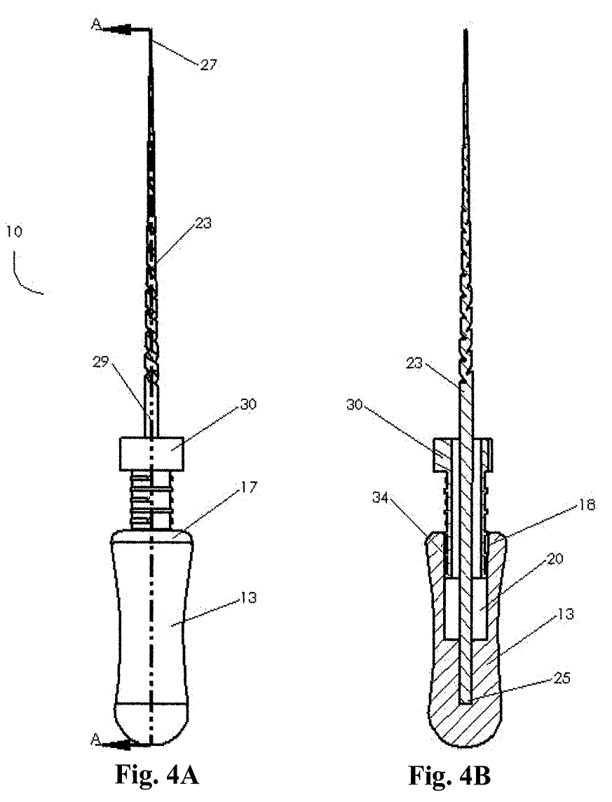

Referring now to FIG. 4B, an endodontic file 10 has a blade 23 that is affixed to an inner surface of the handle 13, such that the blade remains stationary relative to the handle. Consequently, the act of positioning the marker 30 relative to the handle 13, for example as a user moves the marker parallel to the axial line 29, also positions the marker relative to the blade 23, which determines the working length of the endodontic file 10.

Referring to FIG. 4A and FIG. 4B, once the position of the marker 30 is adjusted as selectively desired by a user, an endodontic file 10 has holding means for maintaining the marker 30 in a substantially static position relative to the blade 23. In some embodiments, holding means comprise a marker 30 that is sized appropriately to enter the inner cavity 20 via the opening at the distal end 17 of the handle 13, wherein a portion of the outer surface of the marker 30 is in contact with a portion of the surface of the inner cavity 20. The inner cavity 20 houses a portion of the marker 30. This arrangement provides a range of movement of the marker 30 along the axial line 29, but the movement of the marker 30 along the axial line 29 is opposed by the holding means. The holding means further comprise a plurality of interference ribs 31 on the outer surface of the marker 30. In some embodiments the interference ribs 31 are spaced approximately 0.5 mm apart on the outer surface of the marker 30. Each is raised a distance from the outer surface of the maker 30 sufficient to produce friction between each interference rib 31 and the surface of the inner cavity 20. The friction force resulting from this interference fit serves both to maintain the marker 30 in a substantially static position relative to the blade 23, as selectively desired by a user, and to provide a tactile cue indicative of when the position of the marker 30 has changed. Although the marker 30 is not kept in a totally static or completely immovable relationship relative to the blade 23 and handle 13, the interference fit increases the force needed to adjust the working length of the endodontic file 10. It also provides a tactile cue when such an adjustment is made, which reduces the chances of complications from inadvertent changes to the positioning of the marker 30.

In some embodiments, the interference ribs 31 are staggered such that every other one envelopes the outer surface of the marker 30 circumferentially, while the alternating ones do not envelope the entire circumference of the outer surface. This difference provides another tactile cue that differentiates, for example, a 1 mm adjustment in comparison to a 0.5 mm adjustment.

Optionally, a cutout is placed along a portion of the surface of the inner cavity 20 at the distal end 17 of the handle 13 for increased interference. Optionally, the cutout is along the entire latitudinal surface of inner cavity 20, at a depth substantially equal to the rise of the interference ribs 31.

In some embodiments, the interference ribs 31 are raised sufficient to make the effective outer circumference (if cylindrical) or the effective outer perimeter (if non-cylindrical) of a portion of the marker 30 housed within the handle 13 to be equal to, or greater than, the circumference along the surface of the inner cavity 20. In some embodiments, for example where the effective outer circumference or perimeter of the marker 30 exceeds the inner circumference or perimeter of the inner cavity 20, the marker 30 is made from a deformable material. For example, the marker 30 is formed from materials having a modulus of elasticity within a range of about 9.00 ksi (kilopounds per square inch)-9860 ksi, including all values and increments therebetween. Alternatively, the marker 30 is formed from materials having a modulus of elasticity within a range of about 34.8 ksi-798 ksi, including all values and increments therebetween.

Optionally, the material for the handle 13 is chosen from the group nylon 6, nylon 6,6, nylon 6,10, acrylonitrile butadiene styrene, polycarbonate, polyvinyl chloride, high density polyethylene, polyethylene terephthalate, polyether ether ketone, polypropylene, and polyoxymethylene. In some embodiments, the marker 30 is formed from a material of lesser flexural rigidity than the material used in forming the handle 13.

In some embodiments, as seen in FIG. 4B, the handle 13 includes an alignment taper 18, positioned at the opening near the distal end 17. The alignment taper 18 comprises a beveled edge that urges the proximal end of the marker 30 inward as it approaches the opening into the inner cavity 20 of the handle 13.

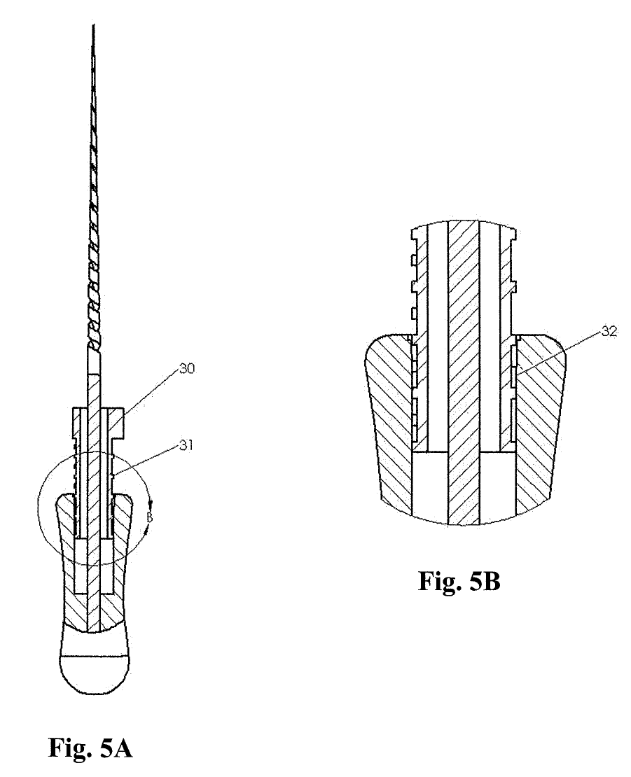

Referring to FIG. 5B, in some embodiments, holding means for maintaining the marker in a substantially static position relative to the blade 23 comprise inner cavity ribs 32 which provide for an interference fit with marker 30 along the surface of the inner cavity 20. In some embodiments, the inner cavity ribs 32 and interference ribs 31 are used in combination. In some embodiments, this combination is a 1:1 fit, wherein the interference ribs 31 and the inner cavity ribs 32 are spaced apart in equal lengths, and there are a like number of each.

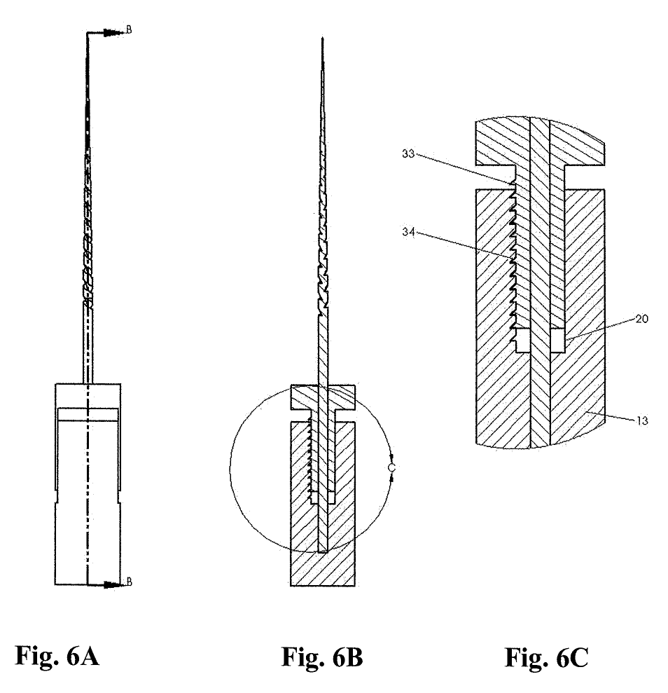

Referring to FIG. 6B and FIG. 6C, in some embodiments, holding means for maintaining the marker in a substantially static position relative to the blade 23 comprise a first set of teeth 33 located on the outer circumference or periphery of the marker 30, which are in a complementary orientation with a second set of teeth 34 located within the inner cavity 20. In some embodiments, the second set of teeth 34 are controlled by a spring lever system (not shown) for positioning the second set 34 for engagement with the first set of teeth 33. The spring lever system works such that compression of the spring enables the second set of teeth 34 to be adjusted into variable positions, and releasing the compression on the spring locks the second set of teeth 34 in contact with the first set of teeth 33. The spring lever system is actuated by a button positioned external to the handle 13 in some embodiments.

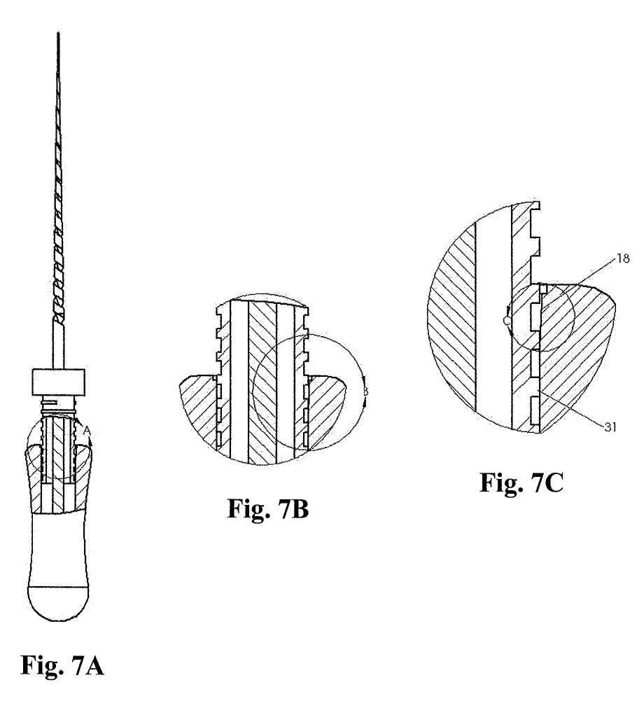

Referring to FIG. 7B and FIG. 7C, in some embodiments, holding means for maintaining the marker in a substantially static position relative to the blade comprise a mating keyhole 37 of handle 13 for actuation with a flat key 36 (not shown) of marker 30. Once the marker 30 is positioned inside the inner cavity 20 of the handle 13, rotation is possible within a range of about 1°-359° of rotation. However, at a point within this range, the flat key 36 of marker 30 engages the mating keyhole 37, resulting in the flat key 36 protruding through the mating keyhole 37, and locking the marker 30 to prevent further rotational and axial movement.

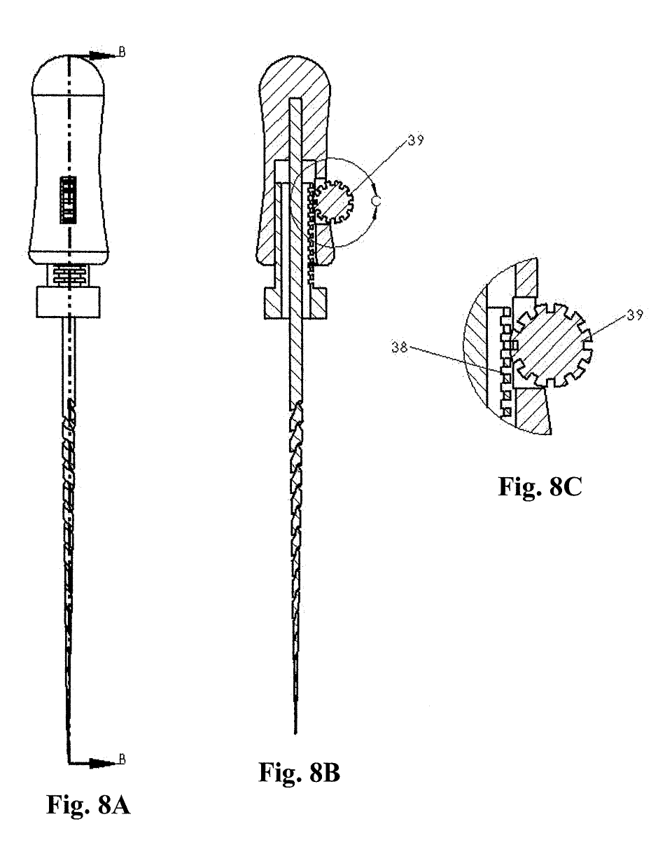

Referring to FIG. 8B and FIG. 8C, in some embodiments, holding means for maintaining the marker in a substantially static position relative to the blade comprise a rack of teeth 38 located on one side of the marker 30. Complementing the rack of teeth 38 is a pinion 39 that meshes with the rack 38. The pinion 39 is controlled by a knob 40 (not shown). The knob 40 is used to position the pinion 39, thereby applying a friction force to pinion 39 that locks the rack 38 in place, and prevents axial movement of the marker 30 parallel to the axial line 29.

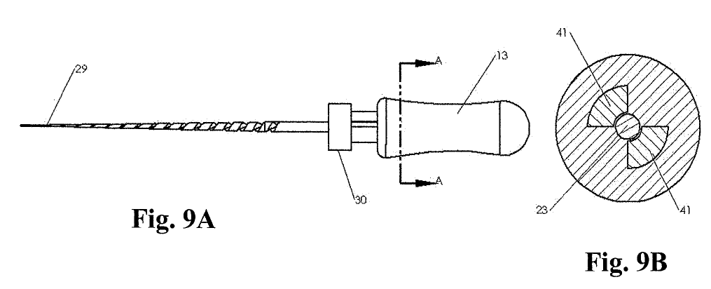

Referring now to FIG. 9A and FIG. 9B, in some embodiments, holding means for maintaining the marker in a substantially static position relative to the blade comprise an overmolded handle that contains at least one longitudinal cut out 41 which allows the marker 30 to move along the axial line 29. In some embodiments, the longitudinal cut out 41 extends parallel to the axial line 29, and is in the form of a partial circle or other geometric shape with three to eight distinct sides. The cutout is adapted to accommodate a portion of the marker 30, and to allow for the marker 30 to enter the inner cavity 20 wherein the marker has a shape complementary to the cutout in order to be retained within the inner cavity 20 of the handle 13. In some embodiments, the marker 30 is adapted to fit within the at least one cutout of the handle 13 by means of a mating geometry. In some embodiments, the mating geometry comprises two non-adjacent quarter circle protrusions from the main section of the marker, that mate with two complementary quarter circle cutouts within the handle 13.

Referring back to FIG. 3, in some embodiments, a portion of the distal end 27 of the blade 23, including the tip at the distal end 27, is coated with a material that provides radiopaque properties in order to provide contrast on x-ray or other radiographic films between the coated portion of the blade 23 and surrounding anatomical structures. The material for such coating is chosen from the group, gold, platinum, iridium, and tungsten. The coating is deposited on the blade 23 through microfusion, which, in some embodiments utilizes two magnetrons opposed with coupled and equivalently unbalanced magnetic fields. Accordingly, the blade 23 is placed between the magnetrons for deposition of the coating material. In this way, the coating is sputtered along the desired location of the surface of the blade 23 to a desired coating level and thickness.

Referring still to FIG. 3, in some embodiments, an adhesive material is applied to at least one point of the endodontic file 10. The adhesive material temporarily maintains contact between the endodontic file and a tooth. In some embodiments, the adhesive material is applied to the marker 30. Optionally, the adhesive material is applied to the distal-most surface edge of the marker 30, which is then placed in contact with the crown of the tooth thereby providing the ability to perform x-rays for measurements without the endodontic file 10 moving relative to the tooth, and without requiring the dental professional to remain in the room while the x-ray is being taken. In some embodiments, the adhesive material is chosen from the group cyanoacrylate and epoxy, such that the adhesive material provides relatively strong tension bonding between the endodontic file 10 and the tooth, while being relatively prone to failure under sheer stresses. These characteristics facilitate a relatively facile twist motion to remove the adhered marker from the tooth.

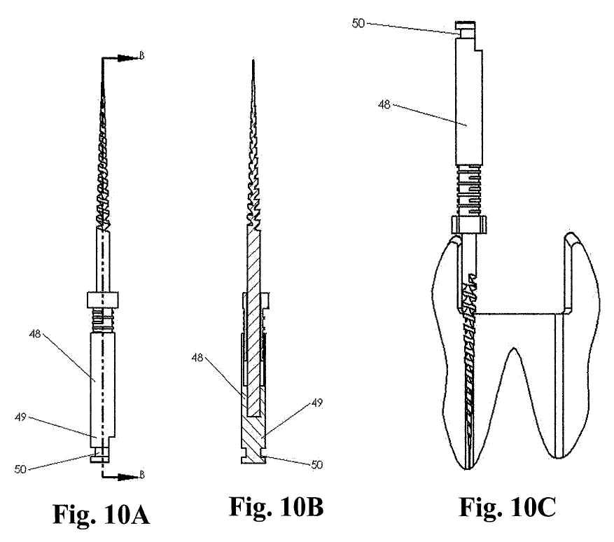

Referring to FIG. 10A and FIG. 10B, in some embodiments, an engine handle 48 is used with the blade 23 and the marker 30 similar to other embodiments described herein. The engine handle 48 is adapted for use with an engine device 42, i.e., an electronic, mechanical, or electromechanical device that generates movements of the blade separate and distinct from those generated by manual manipulation as with a hand file. Optionally, the engine device 42 generates rotational movement of the blade relative to the root canal. Alternatively, the engine device generates oscillating movement of the blade relative to the root canal.

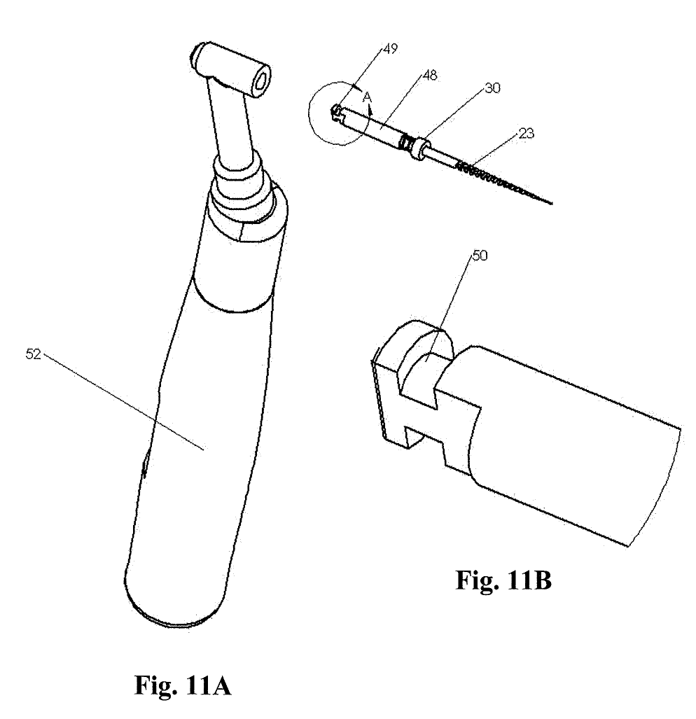

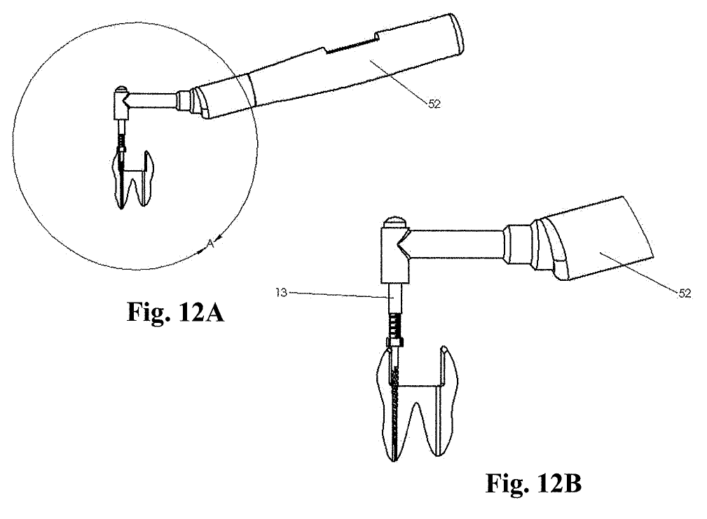

Means for connecting the handle 13 to the engine device include at least one connection key cutout 50 located at or near a proximal end 49 of the handle 48. The connection key cutout 50 comprises a 3-dimensional shape, with a depth that is adapted to lockably fit with a mating element 51 (not shown) of an engine device 42, as illustrated in FIG. 11A. In some embodiments, insert molding or a press fit is utilized to achieve a secure connection between the distal end 25 of the blade 23 within the handle 48. Having been connected with the handle 48 of endodontic file 10, FIG. 12A and FIG. 12B illustrates the engine device in operation as the blade 23 is inserted into a root canal.

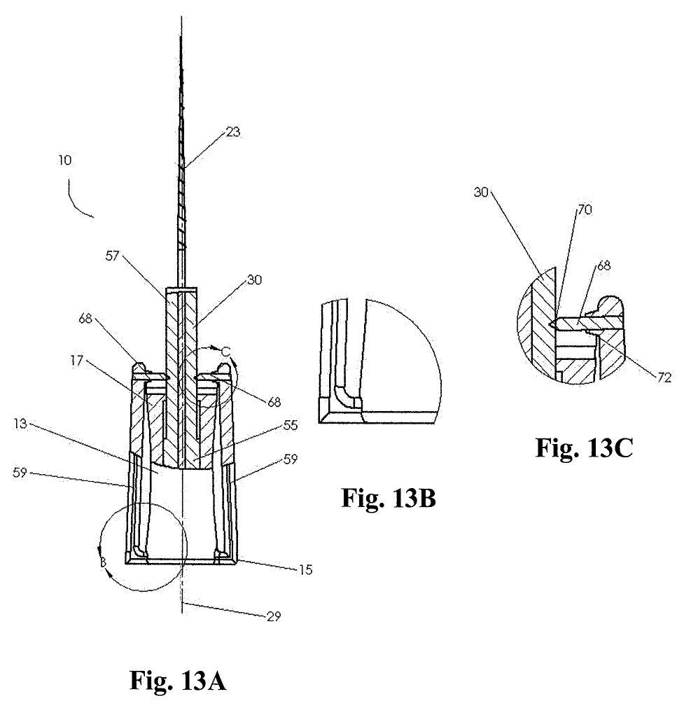

Referring now to FIG. 13A, an endodontic file 10 includes the handle 13 having a proximal end 15 and a distal end 17, and an opening at the distal end 17 leading to an inner cavity 20. In some embodiments, the inner cavity 20 is cylindrically hollow. The position of the marker 30 of the endodontic file 10 enables a dental professional to gauge the working length of the blade 23 relative to a root canal of the tooth. The blade 23 has a proximal end 25 and a distal end 27. The blade 23 defines an axial line 29 relative to the handle 13. The blade 23 is concentric with the cylindrically hollow inner cavity 20 of the handle. Proximally, in some embodiments the blade 23 includes an overmolded end cap that fits securely into the proximal end 15 of the handle 13. Alternatively, the proximal end 25 of the blade 23 is attached within the handle 13.

In some embodiments, the arms 59 are parallel to the axial line 29. Each arm 59 has a needle 68 located at the distal end 67. The marker 30 is positioned substantially around a portion of the outer circumference or periphery of the blade 23, and the marker 30 is partially housed within the handle 13. Optionally, the blade 23 has an end cap (not shown) overmolded onto the proximal end 25, such that the end cap is insert molded, snapped in place or press fit into the proximal end 15 of the handle 13.

In some embodiments, the marker 30 has a proximal end 55 and a distal end 57. The marker 30 moves parallel to the axial line 29 within the handle 13, and at least a portion of the marker 30 is housed within the handle 13. Additionally, at least one arm 59 is attached to the handle 13, wherein each of the at least one arm 59 has a proximal end 65 and a distal end 67. The arm 59 is movable relative to the handle 13. The arm 59 has a needle 68 located on an edge of the arm. Additionally, the handle 13 includes at least one aperture 70 that is sized to accommodate and positioned to receive the needle 68. From time to time herein, arm 59, needle 68, and aperture 70, are referred to in the singular, but the descriptions would also include the plural. Likewise, descriptions of embodiments that refer to the plural would also include the singular.

The endodontic file 10 further comprises needle position securing means, whereby contact between the needle on the and the marker in the engaged position results from the protrusion of the needle through the aperture 70 in order to maintain a friction force on the marker 30 sufficient to retain the marker 30 in a substantially static position relative to the blade as selectably desired by a user.

In some embodiments, the blade 23 is formed from titanium. The marker 30 is formed from a rubber material (e.g., neoprene). The arms 59 are formed from a ductile polymer (e.g., Nylon 6,6), and each needle 68 is formed from titanium or, optionally, steel. Optionally, the needle 68 located at the distal end 67 of each arm 59 is formed from a material having greater rigidity than the material used in forming the marker 30, thus increasing the frictional force upon the marker.

In some embodiments, the needle position securing means comprise two parallel arms attached to the handle 13 and located approximately 180 degrees apart. Optionally, the arms 59 are attached at the proximal end 15 of the exterior of the handle 13. In some embodiments, the arms 59 protrude perpendicularly from the handle 13 at the attachment point. In some embodiments, the arms 59 are permanently attached to the handle 13 chemically such as, for example, in the form of a polymer chain, in order to comprise an unitary body. Alternatively, the arms 59 are attached to the handle 13 using a hinge (not shown), which is optionally in the form of a barrel with cylindrical cutout on one body and mating protrusion in the form of a pin on the other body. Alternatively, the hinge comprises two mating barrels with cylindrical cutout on each body having an external pin completing the connection of the two barrels.

Referring now to FIG. 13B, at the attachment points with the handle 13, the arm 59 turns approximately 90 degrees from the perpendicular to be parallel with the axial line 29. In some embodiments, the arm 59 extends the length of the handle 13 at least as far as the aperture 70. Optionally, the arm 59 extends further than the aperture 70 to facilitate the disengagement, readjustment, and engagement of the needle position securing means, such that engagement and disengagement occur interchangeably as selectably desired by a user. In some embodiments, engagement of the needle position securing means occurs manually, by applying enough force to the arm 59 near the distal end 67 to push the needle 68 through the aperture 70 into contact with the marker 30. Likewise, disengagement of the needle position securing means is performed manually, by removing each needle 68 from the aperture 70 through which it has protruded, thus overcoming the friction stop force upon the marker 30.

In some embodiments, the arm 59 includes an alignment flange 72. The alignment flange 72 is in the form of a cylindrical protrusion positioned on the arm 59 to be received through the aperture 70 in the handle 13. In some embodiments, the alignment flange 72 is chamfered to help urge the needles as they enter the aperture 70. Optionally, the aperture 70 is approximately the same diameter as the needle 68. Alternatively, the aperture 70 is greater in diameter than the needle 68. In some embodiments, the aperture 70 is located at the distal end 17 of the handle 13.

In some embodiments, the inner cavity 20 of the handle 13, being cylindrically hollow, has at least three stepped incremental diametric cut outs that are mutually concentric along with the largest diameter at the surface of the handle 13 along a latitudinal section. The largest cut out diameter is positioned at the proximal end 15 of the handle 13 with the diameter made substantially equal to that of the end cap overmolded on the blade 23. The depth of the largest cut out is substantially equal to that of the end cap of the blade 23. An incrementally smaller diameter second cut out is located distal (along the axial line 29) to the largest cut out. The diameter of the second cut out is substantially equal to the largest outer surface diameter of the portion of the marker 30 that moves within the handle 13. This second cut out provides the moving freedom of the marker 30. An incrementally smaller (than the other two) third cut out is located distal (along the axial line 29) to the other two cut outs, at the distal end 17 of the handle 13. The diameter of the third cut out is substantially equal to the smaller outer diameter of the marker 30 such that the marker 30 passes through the cut out to be viewed during use. The smallest cut out is of a depth sufficient to allow the needle 68 to penetrate the inner cavity 20 of the handle 13. This movement causes the needle 68 to contact the marker 30, and creates a friction force whereby the position of the marker 30 is maintained within the handle 13 relative to the blade 23.

In some embodiments, the overmolded end cap at the proximal end 25 of the blade 23 has an outer circumference less than the space along the inner cavity 20 at the proximal end of the handle 13, which allows the end cap to fit into position and to create a mechanical lock within the handle 13. In some embodiments, the overmolded end cap is chamfered. In some embodiments the endodontic file 10 is an unitary instrument, such that the various structures are integrated and joined within a single instrument.

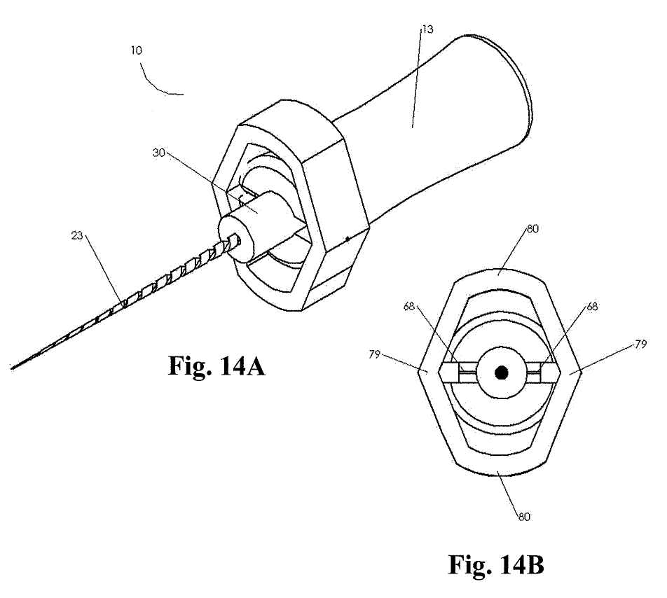

Referring now to FIG. 14A, in some embodiments the handle 13 is contoured such that the outer circumference latitudinally at a central point of the handle is smaller than the diameter of the proximal end 15 and the distal end 17, respectively. Accordingly, the outer surface shape of the handle 13 facilitates manual interaction with the handle 13 of the endodontic file 10 during use by a dental professional. Optionally, the contour is formed as a streamlined curve, a parabolic curve, or a hyperbolic curve, and the outer surface of the proximal end 15 of the handle 13 is rounded.

In some embodiments, needle position securing means are in contact with, but not permanently attached to, the handle 13 of the endodontic file 10. More particularly, needles 68 are positioned at the opening at the distal end 17 of the handle 13. Optionally, the needles 68 are slidably attached to the exterior of the opening, wherein the sliding movement is in a direction substantially perpendicular to axial line 29. The user fits a sheath 78 around the outer circumference of the handle 13. Referring now to FIG. 14B, the sheath 78 contains a plurality of regions of reduced-thickness 79, alternating with a plurality of regions of increased-thickness 80. In some embodiments, the sheath is formed from material chosen from the group nylon 6, nylon 6,6, nylon 6,10, acrylonitrile butadiene styrene, polycarbonate, polyvinyl chloride, aluminum, and steel. The properties of the material is such that application of a compression force to the reduced-thickness regions 79 of the sheath 78 produces a state of compression at those regions, accompanied by a state of extension at the alternating increased-thickness regions 80. By applying a compression force sufficient to hold the sheath 78 in this orientation of alternating regions of compression and extension is applied, the compression of reduced-thickness regions 79 actuates the needles 68 into secure contact with the marker 30, in order to hold the marker 30 in a substantially static position relative to the blade, as selectably desired by a user.

In some embodiments, the needles 68 are positioned near apertures 70 located at the distal end 17 of the handle 13. A compression force as described above moves the needles 68 through the aperture and into contact with the marker 30. In some embodiments, alignment flanges 72 position each needle 68 in alignment with its corresponding aperture 70.

Alternatively, needle position securing means comprise an outer sleeve 77 (not shown) that is adapted to fit tightly around a portion of the handle 13. In some embodiments, this portion of the handle 13 is the distal end 17. In some embodiments, the outer sleeve 77 is formed from material chosen from the group nylon 6, nylon 6,6, nylon 6,10, acrylonitrile butadiene styrene, polycarbonate, polyvinyl chloride, aluminum, and steel. This fit creates a compression force sufficient to actuate the needles 68 into secure contact with the marker 30, in order to hold the marker 30 in a substantially static position relative to the blade, as selectably desired by a user.

In some embodiments, the sheath 78 is used for marker securing means, without the use of needles 68. The sheath 78 is formed from a material having a greater flexural rigidity than the material used in forming the handle. Optionally, the material for the sheath 78 is chosen from the group nylon 6, nylon 6,6, nylon 6,10, acrylonitrile butadiene styrene, polycarbonate, polyvinyl chloride, high density polyethylene, polyethylene terephthalate, polyether ether ketone, polypropylene, and polyoxymethylene. The sheath 78 is adapted to create a compression force at the distal end 17 of the handle 13, sufficient to cause the handle 13 to compress the marker 30 creating a friction stop force upon the marker 30.

Alternatively, the outer sleeve 77 is used for marker securing means, without the use of needles 68. The outer sleeve 77 is formed from a material having a greater flexural rigidity than the material used in forming the handle. Optionally, the material for the outer sleeve 77 is chosen from the group nylon 6, nylon 6,6, nylon 6,10, acrylonitrile butadiene styrene, polycarbonate, polyvinyl chloride, high density polyethylene, polyethylene terephthalate, polyether ether ketone, polypropylene, and polyoxymethylene. The outer sleeve 77 is adapted to create a compression force at the distal end 17 of the handle 13, sufficient to cause the handle 13 to compress the marker 30 creating a friction stop force upon the marker 30.

It will be understood that the embodiments described herein are not limited in their application to the details of the teachings and descriptions set forth, or as illustrated in the accompanying figures. Rather, it will be understood that an endodontic file with working length adjustment scale, as taught and described according to multiple embodiments disclosed herein, is capable of other embodiments and of being practiced or carried out in various ways.

Also, it is to be understood that the phraseology and terminology used herein is for the purpose of description and should not be regarded as limiting. The use herein of “including,” “comprising,” “e.g.,” “containing,” or “having” and variations of those words is meant to encompass the items listed thereafter, and equivalents of those, as well as additional items.

Accordingly, the descriptions herein are not intended to be exhaustive, nor are they meant to limit the understanding of the embodiments to the precise forms disclosed. It will be understood by those having ordinary skill in the art that modifications and variations of these embodiments are reasonably possible in light of the above teachings and descriptions.

What is claimed is:

1. An endodontic file, comprising:
a handle having an inner cavity, a proximal end, and a distal end, wherein the handle is open at the distal end;
a blade having a proximal end and a distal end, the blade defining an axial line relative to the handle, wherein at least a portion of the blade is housed within the handle;
a marker for gauging the working length of the blade relative to a root canal of a tooth; and
holding means,
wherein the marker moves parallel to the axial line, and the holding means maintains the marker in a substantially static position relative to the blade, as selectably desired by a user.

2. The endodontic file of claim 1, further comprising an adhesive material that temporarily maintains contact between the endodontic file and a tooth.

3. The endodontic file of claim 1, further comprising an alignment taper at the distal opening of the handle.

4. The endodontic file of claim 1, wherein the proximal end of the blade is fixed to the handle.

5. The endodontic file of claim 4, further comprising means for connecting the handle to an engine device.

6. The endodontic file of claim 5, wherein the handle is formed from material chosen from the group nylon 6, nylon 6,6, nylon 6,10, acrylonitrile butadiene styrene, polycarbonate, polyvinyl chloride, high density polyethylene, polyethylene terephthalate, polyether ether ketone, polypropylene, and polyoxymethylene.

7. The endodontic file of claim 4, wherein at least a portion of the blade is in the form of a tapered edge.

8. The endodontic file of claim 7, wherein at least a portion of the tapered portion is in a form chosen from the group K-File, Hedstrom File, Helical file, and Reamer.

9. The endodontic file of claim 6 wherein the proximal end of the blade has a constant diameter.

10. The endodontic file of claim 6, wherein the distal end of the blade is coated with a material chosen from the group gold, platinum, iridium, and tungsten.

11. The endodontic file of claim 1, wherein the marker is formed from materials having a modulus of elasticity within a range of about 9.00 ksi-9860 ksi.

12. The endodontic file of claim 1, wherein the marker is formed from materials having a modulus of elasticity within a range of about 34.8 ksi-798 ksi.

13. The endodontic file of claim 1, further comprising a working length adjustment scale.

14. The endodontic file of claim 13, wherein the working length adjustment scale provides a range of working length adjustment from about 0.5 mm-12.0 mm.

15. The endodontic file of claim 13, wherein the working length is adjustable between about 17 mm-26 mm.

16. The endodontic file of claim 13, wherein the working length adjustment scale provides a tactile cue indicative of working length adjustment.

17. The endodontic file of claim 13, wherein the endodontic file is an unitary instrument.

18. The endodontic file of claim 1, wherein the holding means comprises an area of interference fit between the surface of the inner cavity and the outer surface of the marker, wherein the area of interference fit is adapted to limit movement of the marker parallel to the axial line of the blade.

19. An endodontic file, comprising:
a handle having an inner cavity, a proximal end, and a distal end, wherein the handle is open at the distal end;
a blade having a proximal end and a distal end, the blade defining an axial line relative to the handle, wherein at least a portion of the blade is housed within the handle;
a marker for gauging the working length of the blade relative to a root canal of a tooth; and
an adhesive material that temporarily maintains contact between the endodontic file and a tooth.

20. An endodontic file, comprising:
a handle having an inner cavity, a proximal end, a distal end, at least one aperture, and at least one arm, wherein the handle is open at the distal end;
a blade having a proximal end and a distal end, wherein the blade is attached to the handle and defines an axial line relative to the handle, and a portion of the blade is housed within the handle;
a marker having a proximal end and a distal end, wherein at least a portion of the marker is housed within the handle, and the marker moves parallel to the axial line within the handle;
at least one arm, each arm having a proximal end, a distal end, and a needle located on an edge of the at least one arm, wherein at least a portion of the arm is attached to the handle, such that the arm is movable relative to the handle;
wherein the at least one aperture in the handle is sized to accommodate and positioned to receive the needle on the at least one arm;
the endodontic file further comprising needle position securing means, whereby contact between the needle on the at least one arm and the marker in the engaged position results from the protrusion of the needle through the aperture, in order to maintain a friction force on the marker sufficient to retain the marker in a substantially static position relative to the blade, as selectably desired by a user.

21. The endodontic file of claim 20, further comprising means for interchangeably engaging and disengaging the needle position securing means.

22. The endodontic file of claim 21, further comprising an adhesive material that temporarily maintains contact between the endodontic file and a tooth.

23. The endodontic file of claim 21, further comprising an alignment taper at the distal opening of the handle.

24. The endodontic file of claim 21, wherein the proximal end of the blade is fixed to the handle.

25. The endodontic file of claim 21, wherein the marker has a flexural rigidity less than that of the needle located on the at least one arm.

26. The endodontic file of claim 21, further comprising an alignment flange located on the at least one arm.

27. The endodontic file of claim 24, wherein at least a portion of the blade is in the form of a tapered edge.

28. The endodontic file of claim 24, wherein the handle is formed from material chosen from the group nylon 6, nylon 6,6, nylon 6,10, acrylonitrile butadiene styrene, polycarbonate, polyvinyl chloride, high density polyethylene, polyethylene terephthalate, polyether ether ketone, polypropylene, and polyoxymethylene.

29. The endodontic file of claim 27, wherein at least a portion of the tapered portion is in a form chosen from the group K-File, Hedstrom File, Helical file, and Reamer.

30. The endodontic file of claim 27 wherein the proximal end of the blade has a constant diameter.

31. The endodontic file of claim 27, wherein the distal end of the blade is coated with a material chosen from the group gold, platinum, iridium, and tungsten.

32. The endodontic file of claim 21, wherein the marker is formed from materials having a modulus of elasticity within a range of about 9.00 ksi-9860 ksi.

33. The endodontic file of claim 21, wherein the marker is formed from materials having a modulus of elasticity within a range of about 34.8 ksi-798 ksi.

34. The endodontic file of claim 21, further comprising a working length adjustment scale.

35. The endodontic file of claim 34, wherein the working length adjustment scale provides a range of working length adjustment from about 0.5 mm-12.0 mm.

36. The endodontic file of claim 34, wherein the working length is adjustable between about 17 mm-26 mm.

37. The endodontic file of claim 34, wherein the working length adjustment scale provides a tactile cue indicative of working length adjustment.

38. The endodontic file of claim 34, wherein the endodontic file is an unitary instrument.

39. The endodontic file of claim 25, wherein the marker comprises at least two sections having unequal outer diameters, such that the outer diameter of a section near the distal end of the marker is less than the outer diameter of a section near the proximal end.

40. The endodontic file of claim 21, further comprising a plurality of diametric cutouts on the surface of the inner cavity, wherein the cutouts are incrementally smaller moving from the proximal end to the distal end of the handle, wherein a portion of the marker is adapted to fit into at least one of the cutouts to limit movement of the marker parallel to the axial line of the blade.

41. The endodontic file of claim 21, wherein the proximal end of the handle comprises an end cap overmolded onto the blade, and the marker is concentric to the blade.

42. The endodontic file of claim 41, wherein the handle further comprises at least one cutout in the axial direction, in the form of a partial circle or other geometric shape with 3 to 8 distinct sides, wherein the cutout is adapted to accommodate a portion of the marker and is in a form chosen from the group partial circle, triangle, 4-sided polygon, 5-sided polygon, 6-sided polygon, 7-sided polygon, and 8-sided polygon, and further comprising means for maintaining the marker in a substantially static position relative to the handle.

43. The endodontic file of claim 21, wherein the needle position securing means consists of a sheath formed from material chosen from the group nylon 6, nylon 6,6, nylon 6,10, acrylonitrile butadiene styrene, polycarbonate, polyvinyl chloride, aluminum, and steel, wherein the sheath contains alternating regions of reduced-thickness and increased-thickness, and the inner surface of the reduced-thickness regions is adjacent the needle, such that the application of force to the reduced-thickness regions produces a state of compression at the reduced-thickness regions accompanied by a state of extension at the increased-thickness regions, wherein compression of the reduced-thickness regions positions the needle into engagement with the marker.
